(19) United States
(12) Patent Application Publication
(10) Pub. No.: US 2010/0236248 A1
(43) Pub. Date: Sep. 23, 2010

(54) Combustion Liner with Mixing Hole Stub

(76) Inventors: Karthick Kaleeswaran, Bangalore (IN); Ganesh Pejawar Rao, Bangalore (IN); Pankaj Kumar Jha, Bangalore (IN)

Correspondence Address: NIXON & VANDERHYE P.C., 901 NORTH GLEBE ROAD, 11TH FLOOR, ARLINGTON, VA, 22203, US

(21) Appl. No.: 12/406,657

(22) Filed: Mar. 18, 2009

(51) Int. Cl. F02C 1/00

(52) U.S. Cl. 60/752

(57) ABSTRACT

A combustor liner for a gas turbine combustor includes a cooling hole formed in the liner that delivers cooling air into a combustion zone of the combustor. A stub is secured in the cooling hole and is structured to provide added stiffness to an inside edge of the cooling hole. The added stiffness reduces cracking caused by thermal fatigue and provides resistance against high cycle fatigue failures at high frequencies.

### BACKGROUND OF THE INVENTION

The present invention relates generally to gas turbine engines, and, more specifically to combustors therein. In a gas turbine engine, air is pressurized in a compressor and channeled to a combustor, mixed with fuel, and ignited for generating hot combustion gases which flow downstream through one or more turbine stages. In a turbofan engine, a high pressure turbine drives the compressor, and is followed in turn by a low pressure turbine which drives a fan disposed upstream of the compressor.

A typical combustor is annular and axisymmetrical about the longitudinal axial centerline axis of the engine, and includes a radially outer combustion liner and radially inner combustion liner joined at upstream ends thereof to a combustor dome. Mounted in the dome are a plurality of circumferentially spaced apart carburetors each including an air swirler and a center fuel injector. Fuel is mixed with the compressed air from the compressor and ignited for generating the hot combustion gases which flow downstream through the combustor and in turn through the high and low pressure turbines which extract energy therefrom.

A major portion of the compressor air is mixed with the fuel in the combustor for generating the combustion gases. Another portion of the compressor air is channeled externally or outboard of the combustor for use in cooling the combustion liners, while another portion is channeled radially through the combustion liner as a jet of dilution air, which both reduces the temperature of the combustion gases exiting the combustor and controls the circumferential and radial temperature profiles thereof for optimum performance of the turbines.

A combustor is typically cooled by establishing a cooling film of the compressor air in a substantially continuous boundary layer or air blanket along the inner or inboard surfaces of the combustion liners that confine the combustion gases therein. The film cooling layer provides an effective barrier between the metallic combustion liners and the hot combustion gases for protecting the liners against the heat thereof and ensuring a suitable useful life thereof.

In a typical combustor, the film cooling layer is formed in a plurality of axially spaced apart film cooling nuggets which are annular manifolds fed by a plurality of inlet holes, with a downstream extending annular lip which defines a continuous circumferential outlet slot for discharging the cooling air as a film along the hot side of the liners. The rows of nuggets ensure that the film is axially reenergized from row to row for maintaining a suitably thick boundary layer to protect the liners.

In a recent development in combustor design, a multihole film cooled combustor liner eliminates the conventional nuggets and instead uses a substantially uniform thickness, single sheet metal liner with a dense pattern of multiholes to effect film cooling. The individual multiholes are inclined through the liner at a preferred angle of about 20°, with an inlet on the outboard, cold surface of the liner, and an outlet on the inboard, hot surface of the liner spaced axially downstream from the inlet. The diameter of the multiholes is about 20-30 mils (0.51-0.76 mm). This effects a substantially large length to diameter ratio for the multiholes for providing internal convection cooling of the liner therearound. Most significantly, the small inclination angle allows the discharged cooling air to attach along the inboard surface of the liner to establish the cooling film layer which is fed by the multiple rows of the multiholes to achieve a maximum boundary layer thickness, which is reenergized and maintained from row to row in the aft or downstream direction along the combustor liners.

Combustor liner durability in the region of the primary mixing/cooling holes is a concern due to localized hot spots in the vicinity of the mixing holes, which can lead to liner cracking. The hot spots are mainly due to the disturbance to the hot gases by cold jets from the mixing holes leaving the high combustion air in contact with the liner wall. That is, hot combustion gases can be trapped behind cooling jets coming through the mixing holes, thereby causing a temperature increase in the liner near the mixing holes. Such hot spots can result in cracking or other damage to the liner due to thermal fatigue as well as high cycle fatigue (HCF) failures at high frequencies.

### BRIEF DESCRIPTION OF THE INVENTION

In an exemplary embodiment, a combustor liner for a gas turbine combustor includes a cooling hole formed in the liner and a stub secured in the cooling hole. The cooling hole delivers cooling air into a combustion zone of the combustor. The stub is structured to provide added stiffness to an inside edge of the cooling hole.

In another exemplary embodiment, a method of reducing cracking due to thermal fatigue adjacent cooling holes in a gas turbine combustor liner includes a step of securing a stub in the cooling hole, where the stub provides added stiffness to an inside edge of the cooling hole.

In yet another exemplary embodiment, a combustor liner for a gas turbine combustor includes a cooling hole formed in the liner that delivers cooling air into a combustion zone of the combustor. A stub is secured in the cooling hole and includes a plurality of cooling passages disposed substantially surrounding the cooling hole. The cooling passages are angled relative to an axis of the cooling hole in a direction corresponding to a hot gas flow direction through the liner.

### BRIEF DESCRIPTION OF THE DRAWINGS

FIG. 1 is a simplified side cross section of a conventional combustor transition piece aft of the combustor liner;

FIG. 2 is a partial perspective view of a conventional combustor liner and flow sleeve joined to the transition piece;

FIG. 3 is a perspective view of a liner with stubs secured in liner cooling/mixing holes; and

FIG. 4 is a perspective cross-sectional view through the liner and stub.

### DETAILED DESCRIPTION OF THE INVENTION

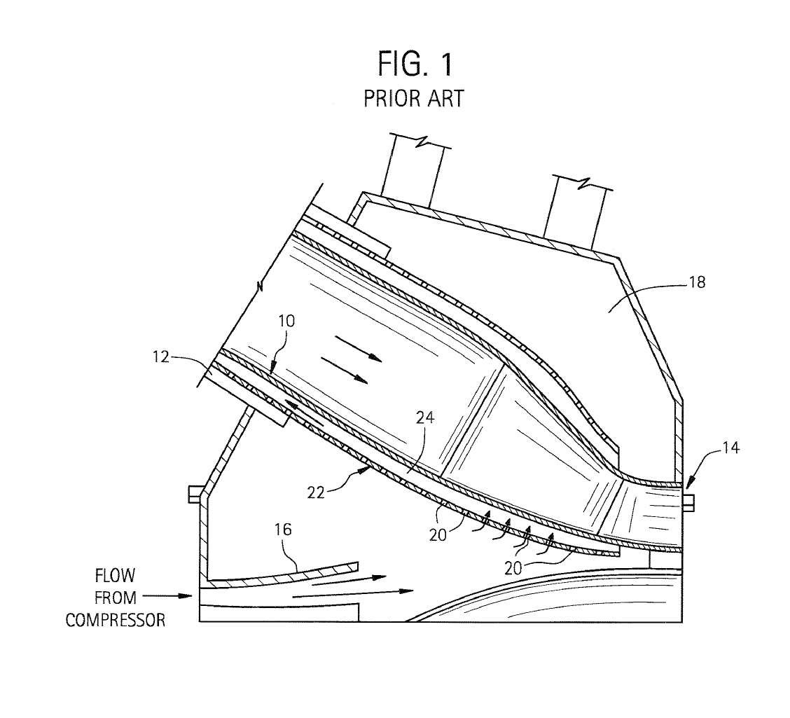

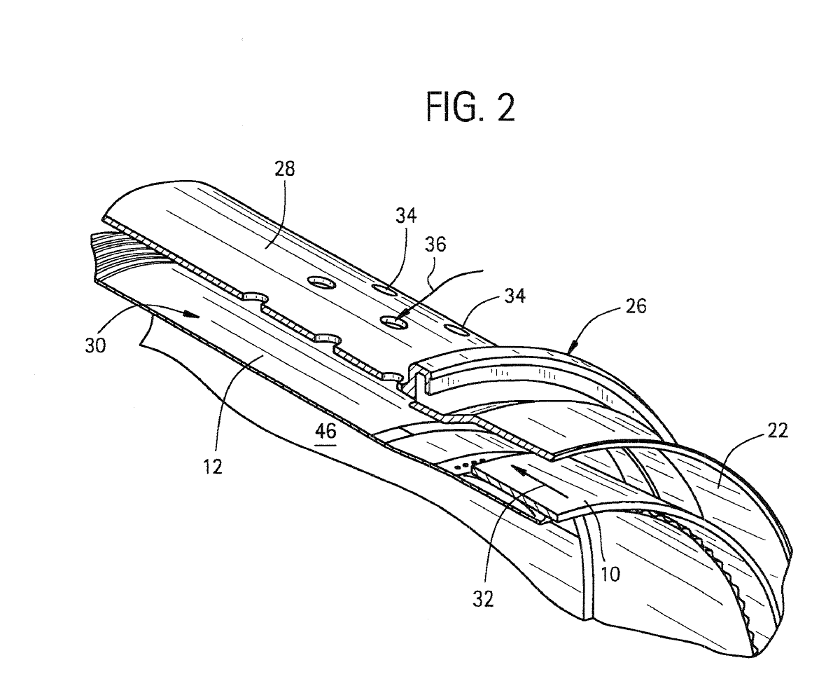

With reference to FIGS. 1 and 2, a typical gas turbine includes a transition piece 10 by which the hot combustion gases from an upstream combustor as represented by the combustor liner 12 are passed to the first stage of a turbine represented at 14. Flow from the gas turbine compressor exits an axial diffuser 16 and enters into a compressor discharge case 18. About 50% of the compressor discharge air passes through apertures 20 formed along and about a transition piece impingement sleeve 22 for flow in an annular region or annulus 24 (or, second flow annulus) between the transition piece 10 and the radially outer transition piece impingement sleeve 22. The remaining approximately 50% of the compressor discharge flow passes into flow sleeve holes 34 of an upstream combustion liner cooling sleeve (not shown) and into an annulus between the cooling sleeve and the liner and eventually mixes with the air in annulus 24. This combined air eventually mixes with the gas turbine fuel in a combustion chamber.

FIG. 2 illustrates the connection between the transition piece 10 and the combustor flow sleeve 28 as it would appear at the far left hand side of FIG. 1. Specifically, the impingement sleeve 22 (or, second flow sleeve) of the transition piece 10 is received in a telescoping relationship in a mounting flange 26 on the aft end of the combustor flow sleeve 28 (or, first flow sleeve), and the transition piece 10 also receives the combustor liner 12 in a telescoping relationship. The combustor flow sleeve 28 surrounds the combustor liner 12 creating a flow annulus 30 (or, first flow annulus) therebetween. It can be seen from the flow arrow 32 in FIG. 2, that crossflow cooling air traveling in the annulus 24 continues to flow into the annulus 30 in a direction perpendicular to impingement cooling air flowing through the cooling holes 34 (see flow arrow 36) formed about the circumference of the flow sleeve 28 (while three rows are shown in FIG. 2, the flow sleeve may have any number of rows of such holes).

Still referring to FIGS. 1 and 2, a typical can annular reverse-flow combustor is shown that is driven by the combustion gases from a fuel where a flowing medium with a high energy content, i.e., the combustion gases, produces a rotary motion as a result of being deflected by blade rings mounted on a rotor. In operation, discharge air from the compressor (compressed to a pressure on the order of about 250-400 lb/in2) reverses direction as it passes over the outside of the combustor liners (one shown at 12) and again as it enters the combustor liner 12 en route to the turbine (first stage indicated at 14). Compressed air and fuel are burned in the combustion chamber, producing gases with a temperature of between about 1500° C. and about 2800° F. These combustion gases flow at a high velocity into turbine section 14 via transition piece 10.

Hot gases from the combustion section in combustion liner 12 flow therefrom into section 16. There is a transition region indicated generally at 46 in FIG. 2 between these two sections. As previously noted, the hot gas temperatures at the aft end of section 12, the inlet portion of region 46, is on the order of about 2800° F. However, the liner metal temperature at the downstream, outlet portion of region 46 is preferably on the order of 1400°-1550° F. To help cool the liner to this lower metal temperature range, during passage of heated gases through region 46, liner 12 is provided through which cooling air is flowed. The cooling air serves to draw off heat from the liner and thereby significantly lower the liner metal temperature relative to that of the hot gases.

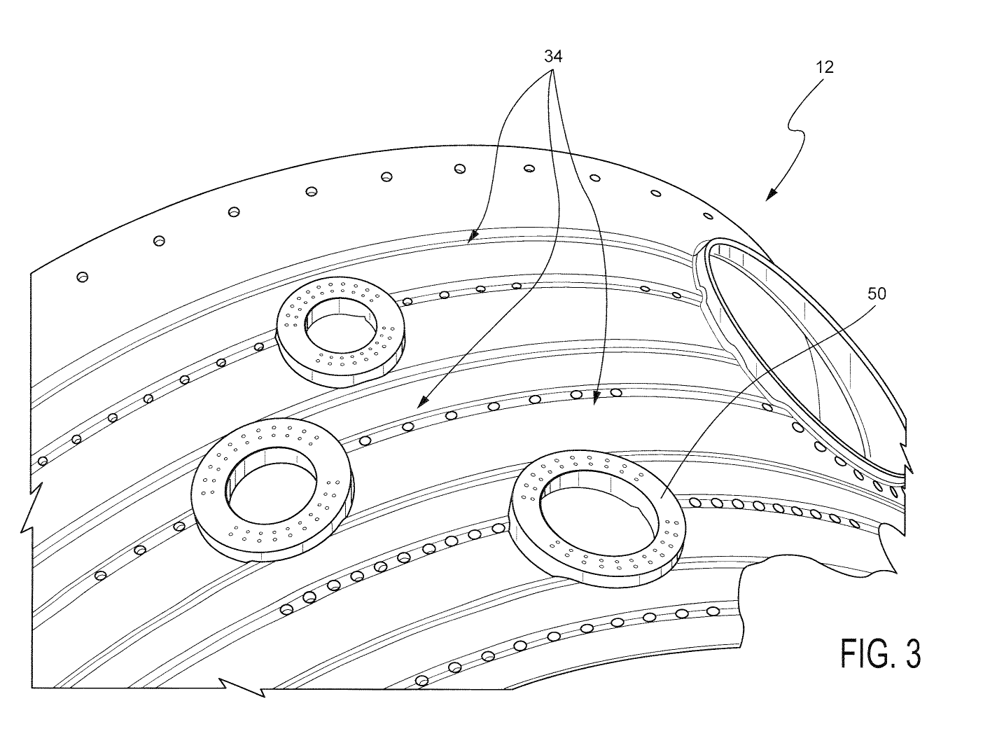

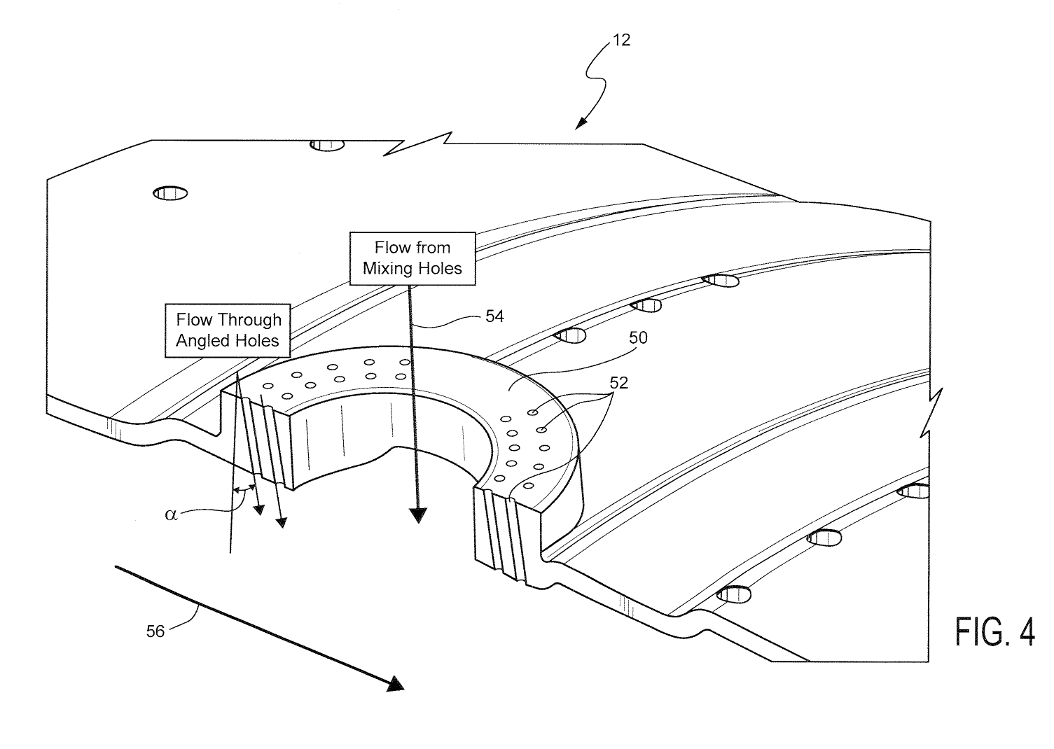

A problem may occur, however, in that hot combustion gases may be trapped behind cooling jets coming through the cooling holes 34. These hot spots can cause cracking due to thermal fatigue or possibly HCF failures at high frequencies. With reference to FIGS. 3 and 4, a stub or stiffening member 50 is secured in one or more of the cooling holes 34 in the liner 12 on the cold side of the liner 12. The stub can be formed of any suitable material such as the same material as the liner. As shown, a thickness of the stub 50 is preferably greater than a thickness of the liner 12. The stub 50 is secured by welding or the like (although brazing, adhesives, mechanical connectors, etc. may be used) in the cooling holes 34 on the inside edge and provides added stiffness at the edge to prevent cracking due to thermal fatigue. The additional stiffness also provides resistance against HCF failures at high frequencies by eliminating some of local modes.

Each stub 50 may include one or a plurality of cooling passages 52 disposed substantially surrounding the cooling hole 34. The cooling passages 52 are preferably oriented at an angle α relative to an axis (represented by arrow 54) of the cooling hole in a direction corresponding to a hot gas flow direction (represented by arrow 56) through the liner 12. That is, as shown in FIG. 4, the cooling passages 52 are angled relative to the cooling hole axis 54 so that the cooling air through cooling passages 52 has at least a directional component in the same direction as the hot gas flow direction 56 through the liner. With the angled cooling passages 52, it is preferred to include two rows of angled passages 52 through the stub to push the hot gases away from the liner wall. Angle α can be any angle up to about 30°, beyond which the air flowing through the cooling passages 52 may have difficulty pushing the hot gases away from the liner wall.

The addition of stubs or stiffening members to the cooling holes in a combustion liner adds stiffness at the cooling hole edge to reduce cracking due to thermal fatigue. The additional stiffness also provides resistance against HCF failures at high frequencies. The angled cooling passages serve to push the hot gases away from the liner wall, thereby cooling the liner wall and the stub. As a result, durability of the liner can be improved.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A combustor liner for a gas turbine combustor comprising:
a cooling hole formed in the liner, the cooling hole delivering cooling air into a combustion zone of the combustor; and
a stub secured in the cooling hole, the stub being structured to provide added stiffness to an inside edge of the cooling hole.

2. A combustor liner according to claim 1, wherein the stub is welded in the cooling hole.

3. A combustor liner according to claim 2, wherein the stub is welded on a cold side of the combustor liner.

4. A combustor liner according to claim 1, wherein a thickness of the stub is greater than a thickness of the liner.

5. A combustor liner according to claim 1, wherein the stub comprises at least one cooling passage.

6. A combustor liner according to claim 5, wherein the at least one cooling passage is angled relative to an axis of the cooling hole.

7. A combustor liner according to claim 6, wherein the at least one cooling passage is angled in a direction corresponding to a hot gas flow direction through the liner.

8. A combustor liner according to claim 6, wherein the at least one cooling passage is angled up to 30° relative to the cooling hole axis.

9. A combustor liner according to claim 1, wherein the stub comprises a plurality of cooling passages disposed substantially surrounding the cooling hole.

10. A combustor liner according to claim 9, wherein the cooling passages are angled relative to an axis of the cooling hole.

11. A combustor liner according to claim 10, wherein the cooling passages are angled in a direction corresponding to a hot gas flow direction through the liner.

12. A combustor liner according to claim 10, wherein the cooling passages are angled up to 30° relative to the cooling hole axis.

13. A method of reducing cracking due to thermal fatigue adjacent cooling holes in a gas turbine combustor liner, the method comprising securing a stub in the cooling hole, the stub providing added stiffness to an inside edge of the cooling hole.

14. A method according to claim 13, wherein the securing step is practiced by welding the stub in the cooling hole.

15. A method according to claim 13, further comprising reducing hotspots adjacent the cooling holes by forming at least one cooling passage in the stub.

16. A method according to claim 15, wherein the forming step is practiced by orienting the at least one cooling passage at an angle relative to an axis of the cooling hole.

17. A method according to claim 16, wherein the at least one cooling passage is angled in a direction corresponding to a hot gas flow direction through the liner.

18. A combustor liner for a gas turbine combustor comprising:
a cooling hole formed in the liner, the cooling hole delivering cooling air into a combustion zone of the combustor; and
a stub secured in the cooling hole, the stub including a plurality of cooling passages disposed substantially surrounding the cooling hole, wherein the plurality of cooling passages are angled relative to an axis of the cooling hole in a direction corresponding to a hot gas flow direction through the liner.
